(19) United States
(12) Patent Application Publication
(10) Pub. No.: US 2007/0152005 A1
(43) Pub. Date: Jul. 5, 2007

(54) Combination motor cycle saddle carry bag and collapsible chair utility

(76) Inventor: Khoa Dang Bui, San Jose, CA (US)

Correspondence Address: Walt Froloff, 273D Searidge Rd, Aptos, CA, 95003, US

(21) Appl. No.: 11/321,839

(22) Filed: Dec. 29, 2005

(51) Int. Cl. B62J 9/00; A45F 4/00; A45F 3/02

(52) U.S. Cl. 224/577; 224/607; 224/413

(57) ABSTRACT

A combination motorcycle saddle pack, carry bag and foldable chair travel utility comprising a plurality of sections and each section having a means for holding a storage compartment, saddle pack convertible to a carry bag or a collapsible chair for use where utility is to be maximized and weight is a premium, where these three functions are useful in one article.

### BACKGROUND OF THE INVENTION

1. Field of the Invention

The field of the present invention relates in general to the fields or transformable multipurpose travel utilities and in particular, a three in one combination motorcycle saddle bag, a carry bag and a collapsible chair.

2. Background

Motorcycle transportation is a low cost and growing mode of transportation, especially in rural and disadvantaged areas. Also, because of shrinking fuel supplies and increasing fuel costs, motorcycle transportation mode is increasing in popularity.

Standard equipment for such cycling includes saddlebags for providing storage for rain-gear, camping equipment, travel accoutrements and supplies. The motorcycle saddlebags typically are slung over and secured just behind the riders seat with side pouches mounted adjacent to the motorcycle frame. Motorcycle saddlebags are also commonly used by an ever-increasing number of commuters and the number of two-wheeled commuters is also growing in major urban centers.

The nature of motorcycle travel and adventure touring often mean traveling with a spartan luggage in tow. In a pinch bicycle saddlebags can double as travel or luggage bags but motorcycle saddlebags are not included in this. Moreover, carry bags are not so accommodating. Unfortunately, most saddlebags are designed to be carried attached to racks and not as luggage by a traveler moving through busy airport terminals or a consumer shopping in a market after they have parked the bicycle and are on foot, seeking to fill the bag before returning laden with goods to carry back. Also lacking are places to sit, as crowded as markets and travel stations are quit often inundated with fellow travelers and shoppers. However, places to stand are usually available.

Alley in U.S. Pat. No. 3,786,972 attempts to address this problem. U.S. Pat. No. 3,786,972 issued Jan. 22, 1974 and discloses a combination bicycle pannier bag, valise and backpack. The combination pack taught by Alley comprises two compartmented bags with each bag having a three-hook harness assembly. According to Alley his harness assembly is an improvement over existing fasteners and in addition provides the capability to convert the pack. In pannier mode each bag is attached to a side of the rack. To convert the compartmented bags to a valise, the harness assembly is fastened to the harness assembly of the other bag to form a unitary satchel from the two bags. In another aspect, the harness assembly taught by Alley allows the compartmented bags to be attached singly or in a superimposed stacked relation to a conventional tubular pack frame to form a backpack.

While Alley provides a bicycle pannier bag assembly, which is convertible to a unitary satchel, the Alley invention is less than satisfactory as a carry bag. The arrangement taught by Alley requires an external tubular pack frame to convert the pannier bags into a backpack. This means that in addition to the bicycle, pannier bags and other gear, the cyclist must also carry a tubular pack frame in order to be able use the pannier bags as a backpack. It will be appreciated that carrying a tubular pack frame without more utility is a waste of traveler energy and effort. The undesirability of this arrangement is further exemplified by the bulky nature of a tubular pack frame, which only serves the one purpose, the backpack. Also, since the motorcycle, much more powerful than a bicycle, can accommodate a much sturdier and large saddle pack than a bicycle, Alley misses the motorcycle market altogether. Furthermore, wheels on luggage fare well on a smooth surface but do nothing to accommodate for rough rural roads. The realities of travel require utilities for multimode travel on urban and rural areas, from to and in markets and airports.

Accordingly, there remains a need in the art for a motorcycle saddle bag assembly which is easily convertible to a carry bag not necessarily a backpack but also convertible to a collapsible chair, to allow one to rest during waiting stops or shopping sprees.

Brule, U.S. Pat. No. 5,765,733, Convertible pack for cycling and backpacking, discloses a pack convertible to a pannier for bicycling and a backpack for hiking. The pack comprises a multiple compartment travel bag. The compartments are attached to a hinged back member. The pack includes a pair of shoulder straps and a waist belt for carrying the pack as a backpack and fastening straps for converting the pack to a backpack. In pannier mode, the hinged back member allows the compartments to attach to each side of a pannier rack and the fastening straps are connected to the shoulder straps to secure the straps out of the way. To convert to a backpack, the fastening straps are cinched together to straighten the back member. When converted to a backpack, the back member forms an internal frame to assist in supporting the load carried by the hiker/cyclist.

While offering some improvements over Alley, Brule is nevertheless concerned with the bicyclist and hiker, not the motorcyclist, shopper, tired shopper weary traveler. Hence Brule is adapted more for bicycles and does not concern itself with the practical constraints of higher speed motorcycle travel, road vibration or muffler heat shields. What is needed is a utility which helps carry but also helps a weary shopper get some rest and relief during the excursion, as well as help in carrying goods.

### SUMMARY OF THE INVENTION

The present invention provides an apparatus for organization and safe transportation of items and accessories in motorcycle travel forming at least one leg of the journey. In a preferred embodiment, a combination motorcycle saddle pack, shoulder carrier bag and foldable chair travel utility is presented. This combination travel utility comprises a motorcycle saddle pack having a plurality of sections with each section having a means for holding a storage compartment, fitting over the rider's back seat and secured to restrain flapping into the wheels or of into the wind. The flexible mid section is constructed of material for folding the saddle pack into a shoulder carrying strap carrier bag, the flexible middle section connecting the sides comprising storage compartments on each side, the side saddle pack sections are secured to the frame when on the motorcycle yet have converting means for converting to a carry bag by un-securing saddle pack from motorcycle and lifting middle saddle pack section allowing the side sections to freely dangle adjacent to each other and adjusting carrying strap over shoulder supporting weight of bag. A frame work of rigid support members are integrated into the side saddle pack sections which convert to an articulated chair frame having at least two cross link member, each of the linkages having a pair of rigid extendable link members, with the cross-link members of each pair being connected to each other at a central axis of the pair for rigid load transfer coupling and extension and connection to an opposite side chair leg. Each of the link members have a segment portion pivotally connecting to the foot end of a chair leg and a member segment portion extending to and rigidly connecting at an upper end of a diagonal opposite frame leg, lower supporting means for connecting the lower ends of the connecting linkages for pivotal movement relative to each other, upper supporting means for connecting the upper ends of linkages for pivotal movement relative to each other, a flexible seat supported by the upper supporting means, the chair having a setup position wherein it rests upon a general horizontally disposed supporting surface with the seat supported in a generally horizontally disposed position, the chair having a collapsed position wherein the chair support means is collapsed and converted into the saddle pack side storage compartment frame or carry baggage.

The combination motorcycle saddle pack carry bag foldable chair utility saddle pack side section frame may also be comprised of a backing board panel.

### BRIEF DESCRIPTION OF THE DRAWINGS

Additional objects and advantages of this invention will become apparent from a consideration of the following drawings and their description.

FIG. 1 is an isometric view of the combination motorcycle saddle pack carry bag foldable chair utility in accordance with a preferred embodiment;

FIG. 2 is a side view of the combination motorcycle saddle pack carry bag collapsible chair utility shown as a motorcycle saddle pack in accordance with a preferred embodiment;

FIG. 3 is a back view of the combination motorcycle saddle pack carry bag foldable chair utility shown as a motorcycle saddle pack in accordance with a preferred embodiment;

FIG. 4 is a top spread eagle view of the combination motorcycle saddle pack carry bag foldable chair utility shown in accordance with a preferred embodiment;

FIG. 5 is an side view of the combination motorcycle saddle pack carry bag foldable chair utility shown as a carry bag in accordance with a preferred embodiment;

FIG. 6 is an isometric view of the combination motorcycle saddle pack carry bag foldable chair utility showing the collapsible chair rigid support configuration in accordance with a preferred embodiment;

FIG. 7 is a bottom spread eagle view of the combination motorcycle saddle pack carry bag foldable chair utility shown as a motorcycle saddle pack in accordance with a preferred embodiment;

FIG. 8 shows detail views of the combination utility shown chair foot fitting coupled to the chair leg with cross link member attachment to footing assembly in accordance with a preferred embodiment;

### DETAILED DESCRIPTION

The present invention is made for the purposes of transporting objects under different transportation modes with the addition of having a transformable collapsible chair to sit on while in transit or waiting for transit, concurrently with staying packed and organized for the next trip segment. The present invention provides a travel utility serving as a motorcycle saddlebag, a carry bag and a collapsible chair.

The present invention addresses the problem of keeping items and objects smartly organized while engaged in motorcycle travel or foot travel with need for transporting items with the added utility of also a place to sit and rest while resting or waiting.

Additional objects and advantages of this invention will become apparent from a consideration of the following drawings and their description.

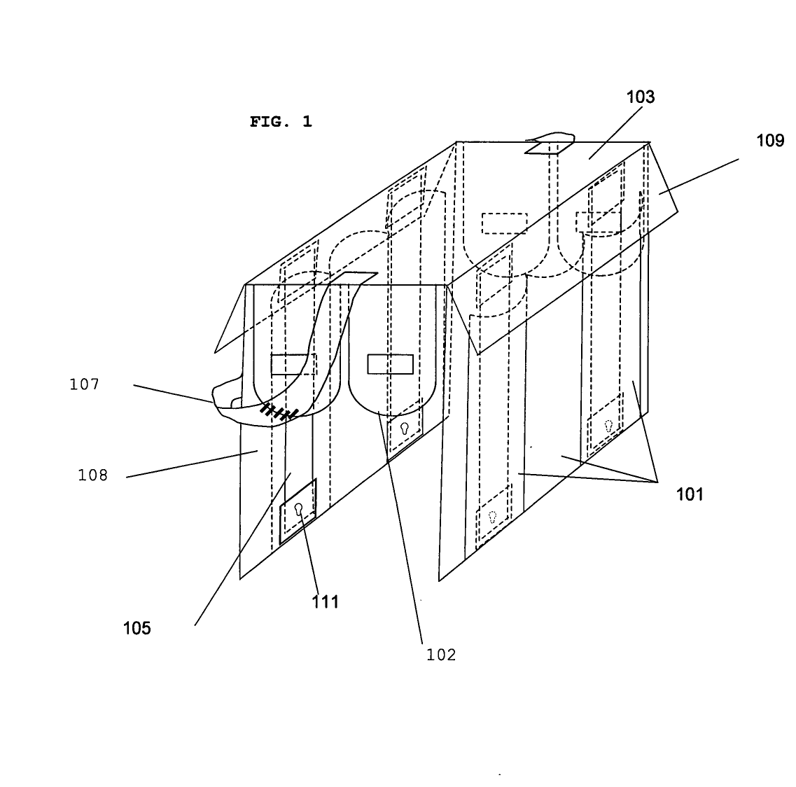

Reference is first made to FIG. 1, an isometric view of the combination motorcycle saddle pack carry bag foldable chair utility in accordance with a preferred embodiment.

The combo utility according to the present invention is transformable between a motorcycle saddle pack, saddle pack mode, suitable for motorcycle transport touring and a carry carrying carrier bag, carrier bag mode, for foot travel as well as a collapsible chair for rest stops, chair mode. In FIG. 1 preferred embodiment, the saddle pack is shown standalone, i.e. shown without the motorcycle. The saddle pack shown in FIG. 1 is conformable to a motorcycle of various rated engine powers, with an extendable midsection 103 which depends only on the width of the motorcycle seat for conformability. The saddle pack mode comprises side storage compartments 101, saddle straps 102, leg support bars 105, backing 108, foot assembly grommet 111, carry strap 107 and padded flap 109. The side leg supports are shown in dotted line fashion to illustrate that they are internal and generally integrated into the utility and not externally visible.

The compartments 101, 205 and 405 may be securely closed with buttons, velco, straps with buckles, zippers, etc, or they may have open access where items are snuggly fit and not susceptible to inadvertent jarring loss from road forces.

The flap 109 may be padded or not, but effectively keeps the weather out and smartly covers the compartment 101, 205 and 405 access ports. The saddle pack has strap, clip or tie-down means for securing the pack to the motorcycle.

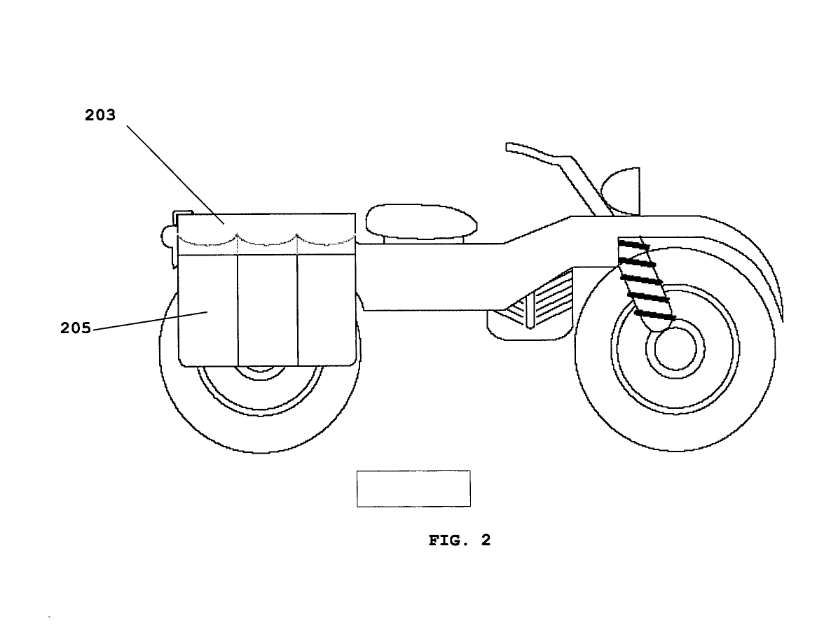

FIG. 2 is a side view of the combination motorcycle saddle pack carry bag collapsible chair utility shown as a motorcycle saddle pack in accordance with a preferred embodiment.

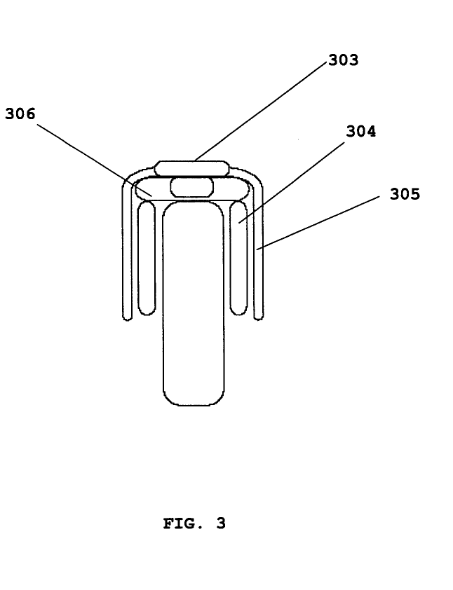

In FIGS. 2 and 3, the combo utility is shown converted for use as a saddle pack. The saddle pack externally appears somewhat extended from conventional design, having design meet the new geometry. The midsection 203 slung over the motorcycle back seat with the two side sections 205 hung parallel to the rear wheel plane and adjacent to the wheel. As shown in the FIGS. 1 2 and 4 embodiments, the saddle pack has three compartments denoted by references 101 205 and 405 and respectively. The compartments 101 205 and 405 are attached to a backing member 108 shown in FIG. 1. The compartments 101 205 and 405 may include internal dividers and pockets for organizing and securing the objects contained inside.

FIG. 3 is a back view of the combination motorcycle saddle pack carry bag foldable chair utility shown as a motorcycle saddle pack in accordance with a preferred embodiment.

FIG. 3 illustrates a preferred embodiment from the rear view in saddle pack mode, the combo pack utility is attached to the rack of the motorcycle 304 as shown in FIG. 3. The two sides 305 attached to the midsection 303 hang over the motorcycle seat and are secured to the respective sides of the motorcycle rack 304 or wheel guard. The midsection is supported by the motorcycle back seat and secured to the motorcycle seat 306 with straps through loops or eyes in flaps.

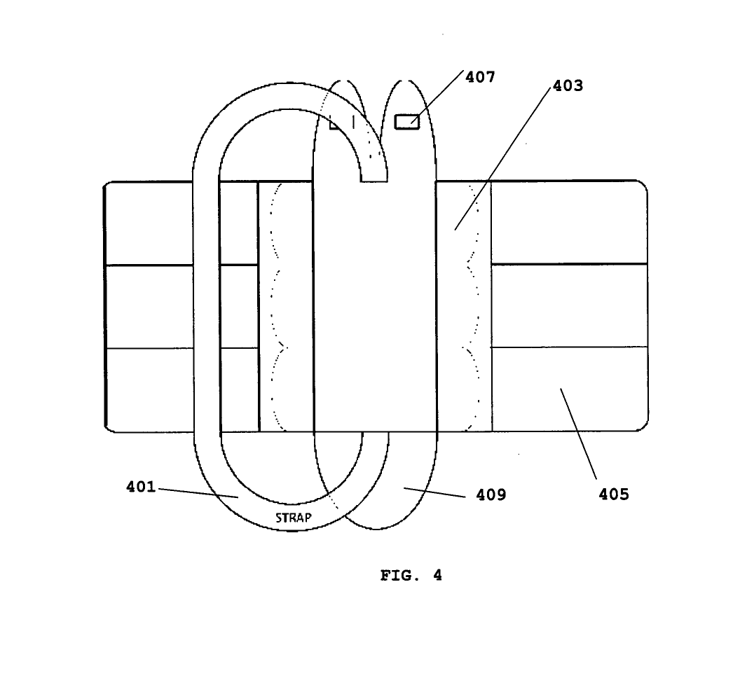

FIG. 4 is a top spread eagle view of the combination motorcycle saddle pack carry bag foldable chair utility shown in accordance with a preferred embodiment. The carrier strap 401 is coupled to the midsection of the combo utility. The midsection of the combo utility has flap-like portions 409 which have slots or eyes 407 through which the strap 401 threads in securing the saddle pack to the motorcycle. The side sections 405 have three compartments shown in this embodiment, but can have any number of larger or smaller and different size compartments and not limited to the three shown in the preferred embodiment. A top flap 403 fits smartly over the compartment access ports to secure and protect objects stored in the side compartments 405 or pockets.

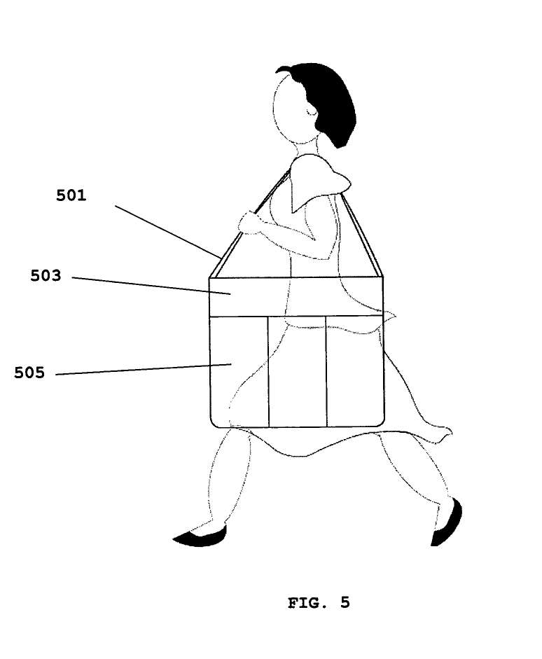

FIG. 5 is an side view of the combination motorcycle saddle pack carry bag collapsible chair utility shown in carry bag as used in typical carry mode in accordance with a preferred embodiment.

There are several advantages for having the present invention in carry bag mode. First, a carrying strap slung over the shoulder as shown in FIG. 5 conveniently carries a folded carry bag. Second, the folding reduces the carry bag size and thus reduces the size of a compartment required to accommodate a folded carry bag, providing a judicious choice of the storage dimensions or volume necessary to accommodate it. This makes it possible for the bag to fit within the overhead compartments of today's commercial aircraft and thus enabling the present invention to be carried aboard aircraft as carry-on baggage on yet another leg of a journey.

Third, because of the divided compartments, there is less shifting of the items enclosed and less friction between items stored.

Fourth, the carry bag can to be carried by a single handle by anchoring a strap at hand grip dimensions in the middle of the midsection portion or by a carrying strap over the shoulder supporting the midsection of the bag as shown in FIG. 5.

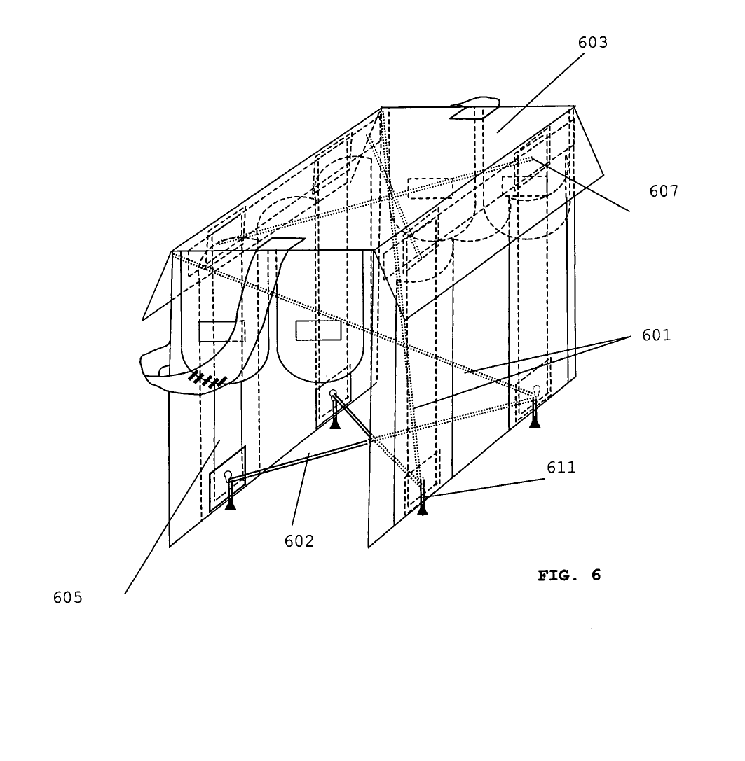

Turning now to FIG. 6, an isometric view of the combination motorcycle saddle pack carry bag foldable chair utility showing the collapsible chair articulated support configuration in accordance with a preferred embodiment.

FIG. 6 illustrates the combination travel utility is shown in converted chair mode. The illustrated chair embodiment has a seat 604 supported by an articulated frame designed generally and formed from a plurality of rigid, some extendable some not, frame members pivotally connected to each other. The chair is situated such that the chair frame normally rests upon a generally horizontal supporting surface and supports the seat 604 in a generally horizontally disposed position. A frame lateral support member 607 pivotally coupled to side leg support members 605 supports the seat 604. The coupling can be a pin connection type but any conventional means mechanically strong enough to transfer the load while providing freedom of rotation at the coupling member 605 607 ends will suffice.

The chair frame comprises at least one of substantially identical pair of cross-link axially extendable members 601, each of which is operatively connects a foot assembly and with its distil end extendable to the diagonally opposite and upper leg member 605, distil end of the cross-link member 601 coupled to the upper portion of the diagonal side leg member 605 by insertion, pin-insertion or any other conventional rigid connection means. The extendable character of the cross-link leg segment 605 can be by axial extension, pivotal hinge mechanism or other conventional means.

Each of the frame member pairs comprises a pair of rigid link members which are axially extendable and can be tubular cylindrical inserted concentrically tubes, rigid slats or rods centrally connected for setup extension relative to each other about a generally horizontally disposed central pivotal axis and each member 601 connected to the other by a bolt, screw, pin or screw bolt which secures the two opposing cross-link members 601 in connected relation to each other for stability.

The frame members 601 605 603 need not be structurally similar and can be comprised of flat slat, cylindrical concentric tube, rod, composite or any other geometry and material which can support a substantially axial load through a cross-link 601 and horizontal cross member 603. The side support 605 and lateral support members 607 would support bending as well as axial loads.

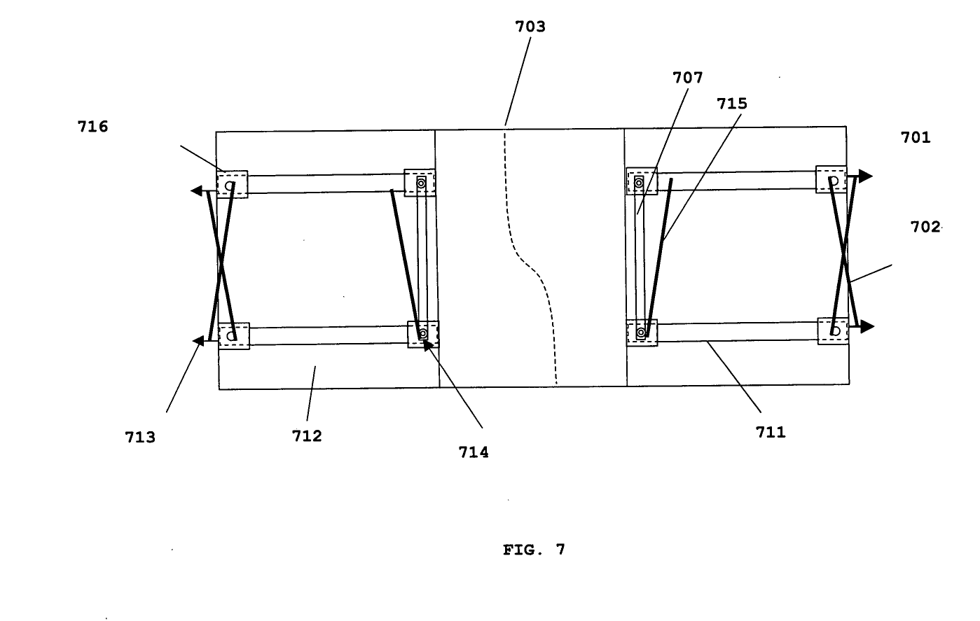

Turning now to FIG. 7, a bottom spread eagle view of the combination motorcycle saddle pack carry bag foldable chair utility shown as a motorcycle saddle pack in accordance with a preferred embodiment.

In accordance with the present invention, the chair frame members are integrated into the combination saddle bag carrier chair utility as shown in FIG. 7, and unfolded as shown in FIG. 6 to transform the utility to its chair mode for seating.

In collapsed mode, the various rigid extendable cross-link 701 and horizontal cross link 702 frame members retract and are secured within or on the utility interior surface 712 to transform into the saddle pack or shoulder carrier mode, as shown for a preferred embodiment in FIG. 5. The utility is comprised of and integrated with flexible material such as cloth, cloth blends, synthetics, leather, plastic, canvas, composite mixture or blend, etc. In addition, the middle section 703 has a locking flexible fold character allowing the utility to conform to the various other modes and to any material used in it manufacture since it must bend and fold to conform to the carry bag or saddle pack operation.

The side support leg 711 is operatively coupled to the lateral support leg 712 through a relatable pin coupling 714 which can support the axial and bending load for a sustaining design capacity. As with the outer segment members 701 702, these segments 711 712 can be comprised of wood, metal rods, light metal tubing, any and all with suitable material strength to support the loading design weight. The outer ends of the side support legs 712 are coupled to a foot assembly 713. The foot assembly is also coupled to the outer link segments 711 712. Conventional methods for material re-enforcement in areas supporting higher stress 716 or wear as shown can also be used in the preferred embodiment.

The upper portion of the unfolded chair is structurally supported by the lateral support members 707 pivotally connected to the leg members 711, and also by the upper cross-link members 715 which are pivotally connected at one end and extendable as for rigid connections on the diagonally opposite side upper leg segment. In another embodiment, this connection will require cross member penetration through a grommet or hole providing access through the outer utility covering to the leg member.

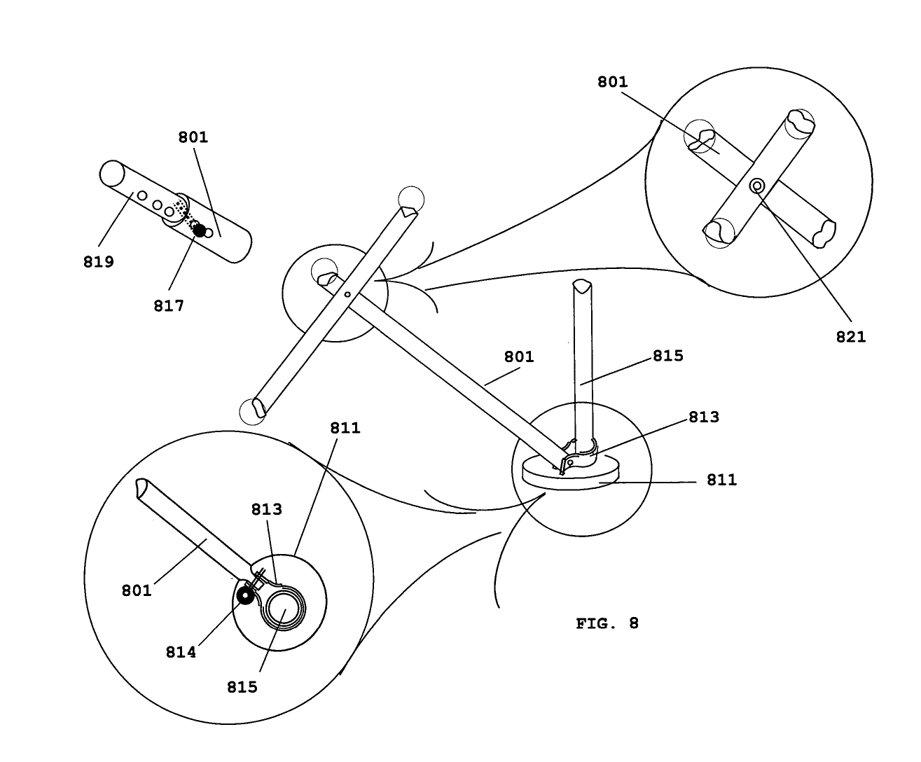

FIG. 8 shows detail views of the combination utility shown as a foot fitting on the chair leg with cross-link member attachment to footing assembly in accordance with a preferred embodiment.

Considering the collapsible chair foot and frame assembly members in more detail we refer to FIG. 8. The articulated frame segments are preferably formed from a plurality of axially extendable segments pivotally connected to each other for movement between the seating mode and the collapsed or transport modes. The articulated frame has at least one pair of extendable laterally spaced apart and generally axially reflective about a perpendicular axis bottom members 801, which extend in generally axially horizontal and diagonal vertical directions when the chair is resting on a substantially horizontal supporting surface in its unfolded chair mode.

Each bottom frame segment member 801 is extendable and operatively connected to a foot assembly 813 as shown in FIG. 8, the distil end separable coupled to the diagonally opposite foot assembly 817 by pin, insertion, pin-insertion or any other conventional means. The extensibility of the cross-link 801 is provided by the concentric or parallel extending member 819 integrated into the cross-link member 801, the distil end of which is coupled to the diagonally opposite side leg end. The segment 801 intersection with an opposite but substantially identical member is coupled by pin 821, insertion through, pin-insertion or any other conventional means of transferring lateral load to the other member.

The assembly rests on a somewhat flattened or dull or flat foot member 811 to which a side leg 815 end is coupled. The cross-link members 801 are structurally coupled to the side leg 815 member via a clamp 813 coupling with pin 814, rivet, bolt or any other conventional means providing free pivot and axial load support sufficient to sustain the design load.

While the invention has been described in detail with reference to preferred embodiments, it is understood that variations and modifications thereof may be made without departing from the true spirit and scope of the invention.

What is claimed is:

1. A combination motorcycle saddle pack, carrier bag and collapsible chair utility comprising:
(a) a convertible motorcycle saddle pack having a plurality of sections and each section having a means for holding a storage compartment, saddle pack comprising;
(i) adjacent side storage compartments slung over each of two sides connected by a middle section, two adjacent side sections positioned freely over a motorcycle seat or seat extension with adjacent sides parallel to wheel plane,
(ii) middle section of flexible material coupled to the adjacent side sections and positioned over seat adjustably,
(iii) means for securing saddle pack side sections to the motorcycle, and
(iv) integrating the saddle pack side adjacent storage compartments with each other and saddle pack.
(b) A convertible carrying bag comprising,
(v) a middle section of flexible construction operatively connected between adjacent side sections comprising storage compartments in each side,
(vi) middle section adjustable length strap means for carrying bag with strap extended over shoulder with ends at carry bag opposite middle section ends for supporting weight of bag, and
(vii) middle section with handle means for lifting or supporting bag while carrying bag at side with arm extended down.
(c) convertible collapsible chair comprising:
(i) an articulated chair frame having at least two cross linkages,
(ii) each of the linkages having a pair of rigid extendable link members,
(iii) at least two of the link members of a pair being adjustably connected to each other at a central axis of the pair for extension and connection to an opposite side chair leg in chair use state,
(iv) at least one cross link members pivotally connecting a lower leg segment extendable to an opposite side lower end segment of a chair leg, adjustably connecting rigidly at the opposite leg end,
(v) at least one of the cross link members having a lower end pivotally connecting to a lower end of a chair leg and extendable with a distil end adjustably and rigidly connected to an opposite leg member upper frame end,
(vi) upper supporting means for connecting the upper chair leg segment ends of the connecting linkages with pivotal movement relative to each other rigidly connecting at the opposite side frame segment leg end,
(vii) lateral supporting members with pivotal load bearing coupling with the upper ends of leg members with pivotal movement relative to each other and forming rigidly attachable joints with extendable cross-link frame members,
(viii) a flexible seat supported by the lateral and leg member supporting means, the chair having a setup position wherein it rests upon a general horizontally disposed supporting surface with the seat supported in a generally horizontally disposed position, the chair having a collapsed position wherein the chair support means collapsible into the saddle pack side storage compartment frame or carry baggage side members storage sides with integrated frame for chair support means.

2. The combination motorcycle saddle pack carry bag foldable chair utility as claimed in claim 1, wherein the saddle pack side section frame comprises a backing board panel frame.

3. The combination saddle pack carry bag foldable chair utility as claimed in claim 2 wherein the backing member comprises one or more sections each having a storage compartment, whereby the utility provides an organized compartment saddle pack.

4. The combination motorcycle saddle pack carry bag foldable chair utility as claimed in claim 1, wherein the link members of each pair being connected to opposite connecting link members at a central axis, link members having movement relative to each other about their connected leg axis.

5. The combination saddle pack carry bag foldable chair utility as claimed in claim 1, wherein the middle section carry strap ends are anchored to the middle section opposite edges and have an extension clasp for strap length adjustment.

6. The combination saddle pack carry bag foldable chair utility as claimed in claim 1, further comprising locking folds in the saddle flexible middle section.

7. The combination saddle pack carry bag foldable chair as claimed in claim 1, further comprising support members made from the set consisting of wood, metal, rod, slat and tubing, any and all with suitable tensile strength.

8. The combination saddle pack carry bag foldable chair as claimed in claim 1, wherein the frame element collapsed mode fastening means comprises a clip, belt, Velcro, tie straps or clamps.

9. The combination saddle pack carry bag foldable chair as claimed in claim 1, wherein the carrying strap comprises an adjustable clasp for strap extension and contraction.

10. The combination saddle pack carry bag foldable chair as claimed in claim 1, wherein the carrying shoulder strap comprises re-enforced anchors at mid section locations serving as strap handle fix positions for flexible handle hand carrying mode.

11. The combination saddle pack carry bag foldable chair as claimed in claim 1, wherein the side sections comprise one or more compartments with a covering flap.

12. The combination saddle pack carry bag foldable chair as claimed in claim 1, wherein chair frame structure comprises cross connections of rigid adjustable length members generally extendable, expendably coupled, and with locking mean such as a pin inserts through concentric cylinders or sliding rigid flat members, and lockable in a single longitudinal axis, otherwise folded and secured to the frame structure or leg segments comprising the frame structure.

13. The combination saddle pack carry bag foldable chair as claimed in claim 1, wherein the cross connector flexible securing means having straps disposed for wrap securing with low cost tie snap or velcro type fastening.

14. The combination saddle pack carry bag foldable chair as claimed in claim 1, wherein the chair leg members are coupled to flat or dull surface extensions supporting the leg member bearing weight.
